(19) United States
(12) Patent Application Publication
(10) Pub. No.: US 2017/0339709 A1
(43) Pub. Date: Nov. 23, 2017

(54) Method and Apparatus for Transmitting Signal and Communications System

(71) Applicant: FUJITSU LIMITED, Kawasaki-shi (JP)

(72) Inventors: Jian ZHANG, Beijing (CN); Xin WANG, Beijing (CN)

(73) Assignee: FUJITSU LIMITED, Kawasaki-shi (JP)

(21) Appl. No.: 15/673,992

(22) Filed: Aug. 10, 2017

Related U.S. Application Data
(63) Continuation of application No. PCT/CN2015/073149, filed on Feb. 16, 2015.

(51) Int. Cl. H04W 72/12; H04W 72/04; H04B 7/06

(52) U.S. Cl. CPC H04W 72/1226; H04B 7/0613; H04W 72/04

(57) ABSTRACT

Embodiments of this disclosure provide a method and apparatus for transmitting a signal and a communications system. The method includes: superimposing, by a transmitting device, symbols which are to be transmitted to multiple pieces of user equipment, to form a superimposed symbol; performing phase rotation on the superimposed symbol to form a rotated symbol; and transmitting the superimposed symbol by using a first antenna and transmitting the rotated symbol by using a second antenna. With the embodiments of this disclosure, channel conditions of multiple pieces of user equipment may be differentiated, and gains of NOMA in a microcell may be fully brought into play.

### CROSS REFERENCE TO RELATED APPLICATIONS

This application is a continuation application of International Application PCT/CN2015/073149 filed on Feb. 16, 2015, the entire contents of which are incorporated herein by reference.

### TECHNICAL FIELD

This disclosure relates to the field of communications, and in particular to a method and apparatus for transmitting a signal and a communications system in a non-orthogonal multiple access (NOMA) system.

### BACKGROUND

A conventional multi-access technology is based on an orthogonal idea, in which multiple orthogonal resources are divided or created to multiplex user equipment. For example, time-division multiple access, frequency-division multiple access and code-division multiple access are all orthogonal multi-access schemes. However, theoretically, non-orthogonal multiple access may achieve a larger capacity domain than an orthogonal scheme.

In order to satisfy a demand of a fifth generation (5G) mobile communications system for supporting a higher throughput and accommodating more connection numbers, the non-orthogonal multiple access is widely studied at present. One of representative techniques is referred to as non-orthogonal multiple access (NOMA).

The NOMA technique is originated from a superimposed code theory, which achieves multiplexing user equipment in a power domain with assistance of successive interference cancellation (SIC), and may achieve a system throughput higher than that of an orthogonal frequency division multiplexing (OFDM) orthogonal multiple access scheme of a 4G mobile communications system.

The NOMA usually schedules user equipment in which channel conditions are different from each other. For example, if a transmitting device proposes transmitting \sqrt{P₁}s₁ to user equipment 1 with relatively good channels and transmitting \sqrt{P₂}s₂ to user equipment 2 with relatively poor channels, it will simultaneously broadcast superimposed signals \sqrt{P₁}s₁+\sqrt{P₂}s₂, and user equipment 1 with relatively good channels will receive h₁(\sqrt{P₁}s₁+\sqrt{P₂}s₂)+n₁, and user equipment 2 with relatively poor channels will receive h₂(\sqrt{P₁}s₁+\sqrt{P₂}s₂)+n₂. The user equipment 2 will be subjected to the signal \sqrt{P₁}s₁ of the user equipment 1 in demodulating s₂; and the user equipment 1 will first demodulate s₂, then perform SIC to remove influence of s₂, and then demodulate s₁.

It is shown by a capacity analysis that the larger a difference between channel conditions of user equipment, the larger of a capacity gain of the NOMA relative to the orthogonal multiple access scheme; on the contrary, if a difference between channel conditions of user equipment is relatively small, a capacity gain of the NOMA is also relatively small. In an extreme case, if user equipment has completely identical channel conditions, the NOMA will bring no capacity gain. As a coverage range of a macro cell is relatively large, it may be deemed that it may relatively easily schedule user equipment with a relatively larger difference between channel conditions, thereby obtaining a relatively outstanding gain of the system throughput.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that a development tendency of future mobile communications is using microcells which are smaller in coverage ranges and denser in deployment. For example, a dense network is studied in both small cell studied in 4G and an ultra-dense network which is one of subjects studied in 5G, so as to obtain a spatial split (reuse) gain. Reduction of a coverage range of a cell will also reduce a pathloss difference between user equipment. And furthermore, channels of the microcell are more and more flat, and especially, taking future use of millimeter waves into account, multi-path components will be far less than those in a case of macrocell, thereby making that most of the channels are of flat attenuation. All of these will result in that a difference of channel conditions between user equipment is insufficiently obvious, hence, gains of NOMA are hard to be brought into play.

Embodiments of this disclosure provide a method and apparatus for transmitting a signal and a communications system in an NOMA system, in which a frequency (and/or time) selective diversity is artificially created by adding extra transmission antennas and using phase rotation, so as to transform flat channels of user equipment into frequency (and/or time) selective channels, and create beneficial conditions for use of the NOMA in a macrocell by enlarging a difference of channel conditions between user equipment by using a characteristic of a small dimension of a channel. And furthermore, with the transform of the phase rotation, gains of a signal spatial diversity may be created and utilized.

According to a first aspect of the embodiments of this disclosure, there is provided a method for transmitting a signal, applied to a non-orthogonal multiple access system, the method including:

superimposing, by a transmitting device, symbols which are to be transmitted to multiple pieces of user equipment, to form a superimposed symbol;

performing phase rotation on the superimposed symbol to form a rotated symbol; and

transmitting the superimposed symbol by using a first antenna and transmitting the rotated symbol by using a second antenna, so that channel conditions of the multiple pieces of user equipment are differentiated.

According to a second aspect of the embodiments of this disclosure, there is provided an apparatus for transmitting a signal, configured in a non-orthogonal multiple access system, the apparatus including:

a superimposing unit configured to superimpose symbols which are to be transmitted to multiple pieces of user equipment to form a superimposed symbol;

a rotating unit configured to perform phase rotation for the superimposed symbol to form a rotated symbol; and

a transmitting unit configured to transmit the superimposed symbol by using a first antenna and transmit the rotated symbol by using a second antenna, so that channel conditions of the multiple pieces of user equipment are differentiated.

According to a third aspect of the embodiments of this disclosure, there is provided a communications system, including:

a base station configured to superimpose symbols which are to be transmitted to multiple pieces of user equipment to form a superimposed symbol, perform phase rotation for the superimposed symbol to form a rotated symbol, and transmit the superimposed symbol by using a first antenna and transmit the rotated symbol by using a second antenna, so that channel conditions of the multiple pieces of user equipment are differentiated.

According to another aspect of the embodiments of this disclosure, there is provided a computer readable program code, which, when executed in a base station, will cause a computer unit to carry out the method for transmitting a signal as described above in the base station.

According to a further aspect of the embodiments of this disclosure, there is provided a computer readable medium, including a computer readable program code, which will cause a computer unit to carry out the method for transmitting a signal as described above in a base station.

An advantage of the embodiments of this disclosure exists in that forming the rotated symbol by performing phase rotation on the superimposed symbol and transmitting the superimposed symbol by using the first antenna and transmitting the rotated symbol by using the second antenna, channel conditions of multiple pieces of user equipment may be differentiated, and gains of NOMA in a microcell may be fully brought into play.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of transmission of a conventional single antenna;

FIG. 2 is a schematic diagram of an artificial diversity method of an embodiment of this disclosure;

FIG. 3 is a schematic diagram of transforming a flat channel into a frequency selective channel of the embodiment of this disclosure;

FIG. 4 is a schematic diagram of the method for transmitting a signal of the embodiment of this disclosure;

FIG. 5 is a schematic diagram of an NOMA artificial diversity of the embodiment of this disclosure;

FIG. 6 is a schematic diagram of non-NOMA frequency selective scheduling;

FIG. 7 is another schematic diagram of the NOMA artificial diversity of the embodiment of this disclosure;

FIG. 8 is a schematic diagram of NOMA frequency selective scheduling of the embodiment of this disclosure;

FIG. 9 is another schematic diagram of the NOMA frequency selective scheduling of the embodiment of this disclosure;

FIG. 10 is a further schematic diagram of the NOMA frequency selective scheduling of the embodiment of this disclosure;

FIG. 11 is another schematic diagram of the method for transmitting a signal of the embodiment of this disclosure;

FIG. 12 is a schematic diagram of a signal spatial diversity of the embodiment of this disclosure;

FIG. 13 is a schematic diagram of the apparatus for transmitting a signal of an embodiment of this disclosure;

FIG. 14 is another schematic diagram of the apparatus for transmitting a signal of the embodiment of this disclosure;

FIG. 15 is a schematic diagram of a structure of a transmitting device of an embodiment of this disclosure; and

FIG. 16 is a schematic diagram of the communications system of an embodiment of this disclosure.

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

Under a microcell environment, user equipment often experiences flat channels, and there exists no relatively large difference between large-scale attenuation of channels between user equipment as it does in a macrocell, which is disadvantageous to bringing gains of the NOMA into play. In the embodiments of this disclosure, equivalent channels of user equipment intensely change in a frequency domain (or a time domain) by artificially creating a frequency (or time) selective diversity by adding an antenna, which may provide multi-user diversity gains for NOMA subband scheduling.

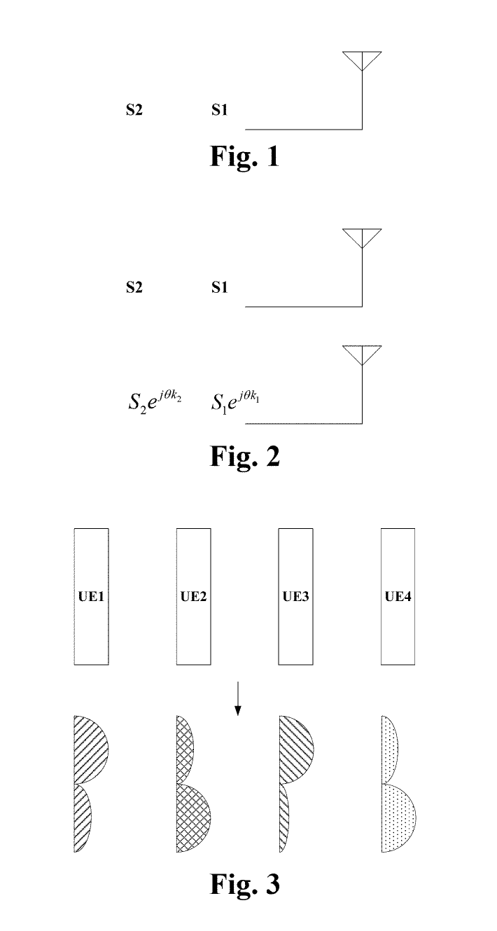

Taking single antenna transmission as a conventional method, FIG. 1 is a schematic diagram of transmission of a conventional single antenna, and FIG. 2 is a schematic diagram of an artificial diversity method of an embodiment of this disclosure. As shown in FIG. 1, two symbols S1 and S2 different from each other in the frequency domain are transmitted via an antenna.

In FIG. 2, θ denotes an angle of phase rotation, and k1 and k2 denote different frequency positions, such as different subcarriers. For user equipment 1, it is assumed that channel responses between user equipment 1 and two transmission antennas are h11 and h12, an equivalent channel experienced by symbol S1 in subcarrier k1 is h₁₁+h₁₂e^{jθk}^{₁}, an equivalent channel experienced by symbol S2 in subcarrier k2 is h₁₁+h₁₂e^{jθk}^{₂}, and different weights result in frequency domain selectivity of the channels. Likewise, an equivalent channel experienced by user equipment 2 is also a frequency domain selective channel.

FIG. 3 is a schematic diagram of transforming a flat channel into a frequency selective channel of an embodiment of this disclosure. As shown in FIG. 3, it is possible that user equipment having a relatively large channel condition difference is created. For example, for a subband, user equipment 1 has a relatively good channel condition, while user equipment 2 has a relatively poor channel condition.

How to create artificial diversity by adding a transmission antenna is illustrated above by taking a frequency domain as an example. Embodiments of this disclosure shall be further described below.

### Embodiment 1

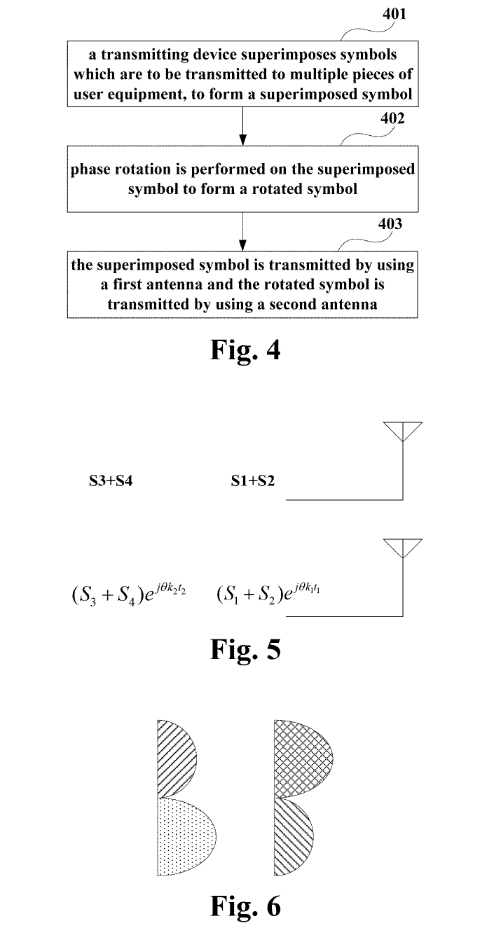

Embodiment 1 of this disclosure provides a method for transmitting a signal, applied to an NOMA system. FIG. 4 is a schematic diagram of the method for transmitting a signal of the embodiment of this disclosure. As shown in FIG. 4, the method includes:

step 401: a transmitting device superimposes symbols which are to be transmitted to multiple pieces of user equipment, to form a superimposed symbol;

step 402: phase rotation is performed on the superimposed symbol to form a rotated symbol; and

step 403: the superimposed symbol is transmitted by using a first antenna and the rotated symbol is transmitted by using a second antenna, so that channel conditions of the multiple pieces of user equipment are differentiated.

In this embodiment, the transmitting device may superimpose the symbols to be transmitted to multiple pieces of user equipment based on the NOMA technique to form the superimposed symbol. It should be appreciated that in the embodiment of this disclosure, for the sake of simplicity, power is omitted and only, for example, S1+S2, is used to denote the superimposed symbol, which should be in a form of, for example, \sqrt{P₁}s₁+\sqrt{P₂}s₂, and is easily understood by those skilled in the art.

In this embodiment, the rotated symbol may be:

(s₁+s₂)e^{jθk}^{ᵢ}^{t}^{ᵢ}; or

(s₁+s₂)e^{jθk}^{ᵢ}; or

(s₁+s₂)e^{jθt}^{ᵢ};

where, S1 and S2 are symbols respectively to be transmitted for first user equipment and second user equipment, θ is a predetermined phase value, kᵢ is a factor in a frequency domain, and tᵢ is a factor in a time domain.

In this embodiment, a rotation factor of the phase rotation, such as e^{jθk}^{ᵢ}^{t}^{ᵢ} or e^{jθk}^{ᵢ} or e^{jθt}^{ᵢ}, introduces time disturbance and/or frequency disturbance into a channel, and the superimposed symbol is transmitted by using the first antenna and the rotated symbol is transmitted by using the second antenna in the same time-frequency resource.

FIG. 5 is a schematic diagram of an NOMA artificial diversity of the embodiment of this disclosure. As shown in FIG. 5,

for the superimposed symbol (S1+S2), a rotated symbol (S₁+S₂)e^{jθk}^{₁}^{t}^{₁} may be obtained after phase rotation is performed; and then in the same time-frequency resource, the superimposed symbol (S1+S2) is transmitted by using the first antenna, and the rotated symbol (S₁+S₂)e^{jθk}^{₁}^{t}^{₁} is transmitted by using the second antenna;

and for the superimposed symbol (S3+S4), a rotated symbol (S₃+S₄)e^{jθk}^{₁}^{t}^{₁} may be obtained after phase rotation is performed; and then in the same time-frequency resource, the superimposed symbol (S3+S4) is transmitted by using the first antenna, and the rotated symbol (S₃+S₄)e^{jθk}^{₂}^{t}^{₂} is transmitted by using the second antenna.

Hence, the channel is made to fluctuate in the frequency domain (identified by kᵢ) and/or the time domain (identified by tᵢ) to differentiate the channel conditions of the multiple pieces of user equipment, and facilitate acquiring NOMA gains.

For the sake of simplicity in the following, description shall be given taking the frequency domain only as an example.

In this embodiment, multiple pieces of user equipment may be selected according to the channel conditions to perform NOMA scheduling.

FIG. 6 is a schematic diagram of non-NOMA frequency selective scheduling. As shown in FIG. 6, only one piece of user equipment is scheduled within the same subband, and each subband schedules user equipment with relatively good channel conditions.

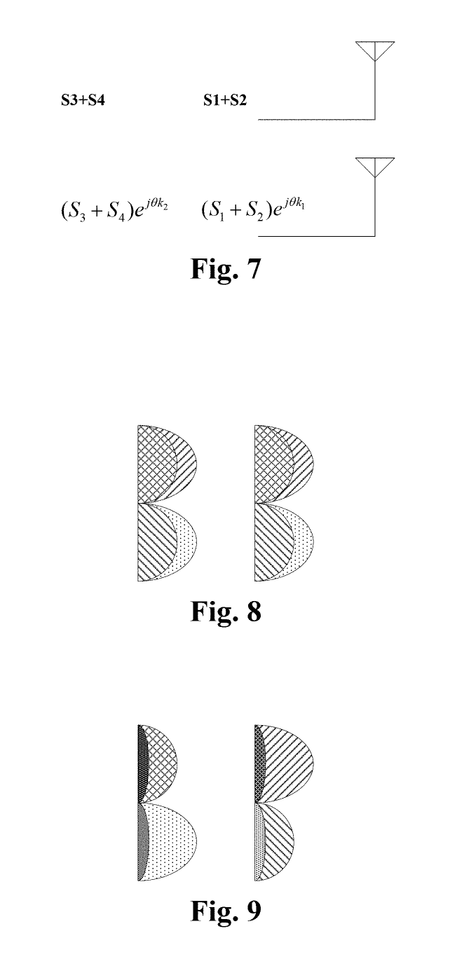

FIG. 7 is another schematic diagram of the NOMA artificial diversity of the embodiment of this disclosure, in which a case where a frequency selective channel is obtained via an NOMA artificial diversity is shown. NOMA transmission is performed based on the artificial diversity, and in the frequency selective channel, a channel difference between intra-subband user equipment is enlarged, thereby providing more freedom for the NOMA scheduling.

In an implementation, two or more pieces of user equipment (such as user equipment of channel conditions exceeding a predetermined threshold) in the same sub-band may be scheduled for the purpose of maximizing a throughput. FIG. 8 is a schematic diagram of NOMA frequency selective scheduling of the embodiment of this disclosure. As shown in FIG. 8, two pieces of user equipment of best channels may be simultaneously scheduled within the same subband by power domain multiplexing in the NOMA scheduling. At this moment, a throughput higher than that shown in FIG. 6 may be reached.

In another implementation, two or more pieces of user equipment with a difference between channel conditions thereof larger than the predetermined threshold may be scheduled in the same sub-band for the purpose of ensuring a performance of successive interference cancellation. FIG. 9 is another schematic diagram of the NOMA frequency selective scheduling of the embodiment of this disclosure. As shown in FIG. 9, two pieces of user equipment with a relatively large difference between channel conditions may be selected for scheduling, which is advantageous to improvement of a first-grade demodulation performance of the successive interference cancellation.

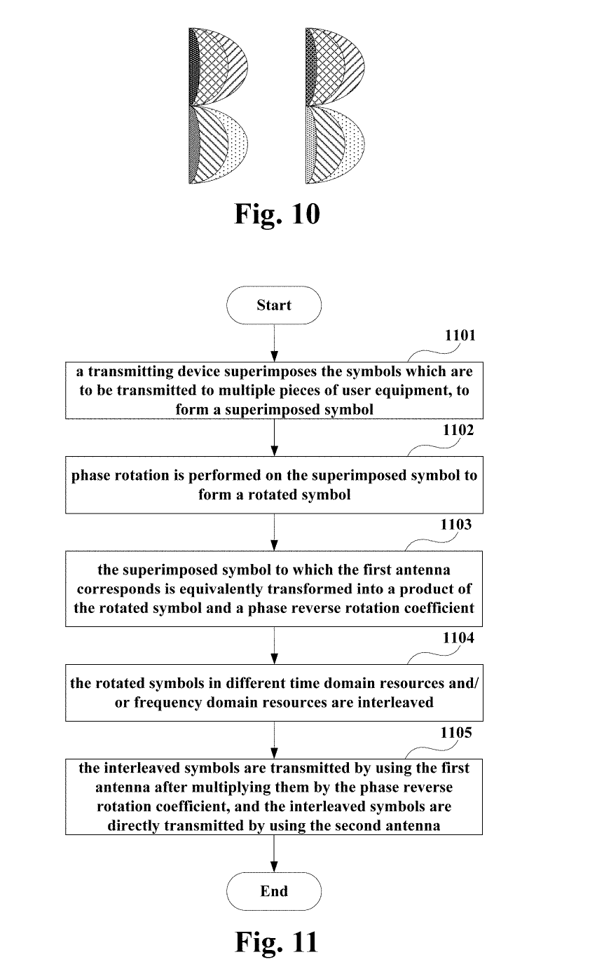

In a further implementation, two or more pieces of user equipment of channel conditions different from each other may be scheduled in the same sub-band for the purpose of maximizing the number of users that are scheduled. FIG. 10 is a further schematic diagram of the NOMA frequency selective scheduling of the embodiment of this disclosure. As shown in FIG. 10, as the channel difference of the user equipment within the subband is enlarged, it is possible that the NOMA multiplexes more user equipment in the power domain.

It should be appreciated that FIGS. 7-10 only schematically show some implementations of performing NOMA scheduling by the frequency selective channel. However, this disclosure is not limited thereto, and a particular implementation may be determined according to an actual situation.

In this embodiment, signal spatial diversity may be introduced into the NOMA artificial diversity.

FIG. 11 is another schematic diagram of the method for transmitting a signal of the embodiment of this disclosure. As shown in FIG. 11, the method includes:

step 1101: a transmitting device superimposes the symbols which are to be transmitted to multiple pieces of user equipment, to form a superimposed symbol;

step 1102: phase rotation is performed on the superimposed symbol to form a rotated symbol;

step 1103: the superimposed symbol to which the first antenna corresponds is equivalently transformed into a product of the rotated symbol and a phase reverse rotation coefficient;

step 1104: the rotated symbols in different time domain resources and/or frequency domain resources are interleaved; and

step 1105: the interleaved symbols are transmitted by using the first antenna after multiplying them by the phase reverse rotation coefficient, and the interleaved symbols are directly transmitted by using the second antenna.

In this embodiment, the product of the rotated symbol and the phase reverse rotation coefficient may be expressed as:

(s₁+s₂)e^{jθk}^{ᵢ}e^{-jθk}^{ᵢ}; or

(s₁+s₂)e^{jθt}^{ᵢ}e^{-jθt}^{ᵢ}; or

(s₁+s₂)e^{jθk}^{ᵢ}^{t}^{ᵢ}e^{-jθk}^{ᵢ}^{t}^{ᵢ};

where, S1 and S2 are symbols respectively to be transmitted for the first user equipment and the second user equipment, θ is a predetermined phase value, kᵢ is a frequency domain factor, and tᵢ is a factor in the time domain.

Then, real part and imaginary part interleaving may be performed on the obtained symbol, such as (s₁+s₂)e^{jθk}^{ᵢ} or (s₁+s₂)e^{jθt}^{ᵢ} or (s₁+s₂)e^{jθk}^{ᵢ}^{t}^{ᵢ}. The interleaved symbols are transmitted by using the first antenna after multiplying them by the phase reverse rotation coefficient (such as e^{-jθk}^{ᵢ} or e^{-jθt}^{ᵢ} or e^{-jθk}^{ᵢ}^{t}^{ᵢ}), and the interleaved symbols are transmitted directly by using the second antenna.

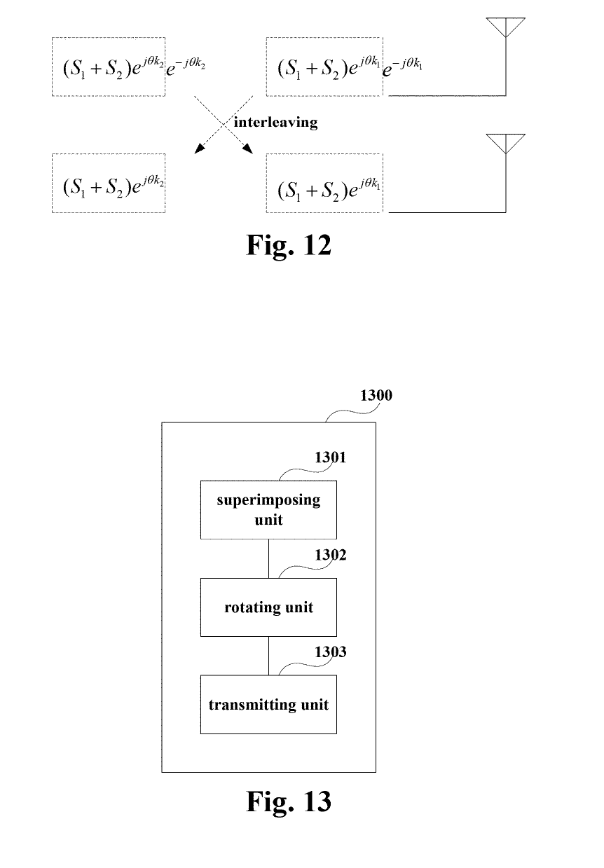

FIG. 12 is a schematic diagram of a signal spatial diversity of the embodiment of this disclosure, which is described taking the frequency domain as an example. As shown in FIG. 12, a common phase rotation coefficient e^{jθk}^{ᵢ} is extracted from each antenna, and real part and imaginary part interleaving is performed on the obtained symbol, such as (s₁+s₂)e^{jθk}^{₁}^{t}^{₁}, or (s₁+s₂)e^{jθk}^{₂}^{t}^{₂}, etc.; and the interleaved symbol is still transmitted via the antenna after being weighted. After the symbol is received at a receiving device, it is first de-interleaved, and then is demodulated and decoded. The relevant art may be referred to for interleaving of the symbol, which is not limited in this embodiment.

In this embodiment, for different user equipment performing the NOMA, different phase rotation values, i.e. different values of θ, may be used. For example, a pair of user equipment (UE1 and UE2) performing the NOMA use θ1, and another pair of user equipment (UE3 and UE4) performing the NOMA use θ2.

In this embodiment, a phase value of the phase rotation may be configured for the user equipment explicitly by the transmitting device, or acquired by the user equipment implicitly; for example, it is obtained by multiplying a fixed angle by a user equipment ID.

It can be seen from the above embodiment that, by forming the rotated symbol by performing phase rotation on the superimposed symbol and transmitting the superimposed symbol by using the first antenna and transmitting the rotated symbol by using the second antenna, channel conditions of multiple pieces of user equipment may be differentiated, and gains of NOMA in a microcell may be fully brought into play. Furthermore, with the transform and interleaving of the phase rotation symbols, gains of a signal spatial diversity may be created and utilized.

### Embodiment 2

The embodiment of this disclosure provides an apparatus for transmitting a signal, configured in an NOMA system. This embodiment corresponds to the method for transmitting a signal of Embodiment 1, with identical contents being not going to be described herein any further.

FIG. 13 is a schematic diagram of the apparatus for transmitting a signal of the embodiment of this disclosure. As shown in FIG. 13, the apparatus 1300 includes:

a superimposing unit 1301 configured to superimpose symbols which are to be transmitted to multiple pieces of user equipment to form a superimposed symbol;

a rotating unit 1302 configured to perform phase rotation for the superimposed symbol to form a rotated symbol; and

a transmitting unit 1303 configured to transmit the superimposed symbol by using a first antenna and transmit the rotated symbol by using a second antenna, so that channel conditions of the multiple pieces of user equipment are differentiated.

In this embodiment, the rotated symbol may be expressed as:

(s₁+s₂)e^{jθk}^{ᵢ}^{t}^{ᵢ}; or

(s₁+s₂)e^{jθk}^{ᵢ}; or

(s₁+s₂)e^{jθt}^{ᵢ};

where, S1 and S2 are symbols respectively to be transmitted for first user equipment and second user equipment, θ is a predetermined phase value, kᵢ is a factor in a frequency domain, and tᵢ is a factor in a time domain.

In this embodiment, a rotation factor of the phase rotation introduces time disturbance and/or frequency disturbance into a channel, so that the channel fluctuates in the frequency domain and/or the time domain to differentiate the channel conditions of the multiple pieces of user equipment. The transmitting unit 1303 is configured to transmit the superimposed symbol by using the first antenna and transmit the rotated symbol by using the second antenna in the same time-frequency resource.

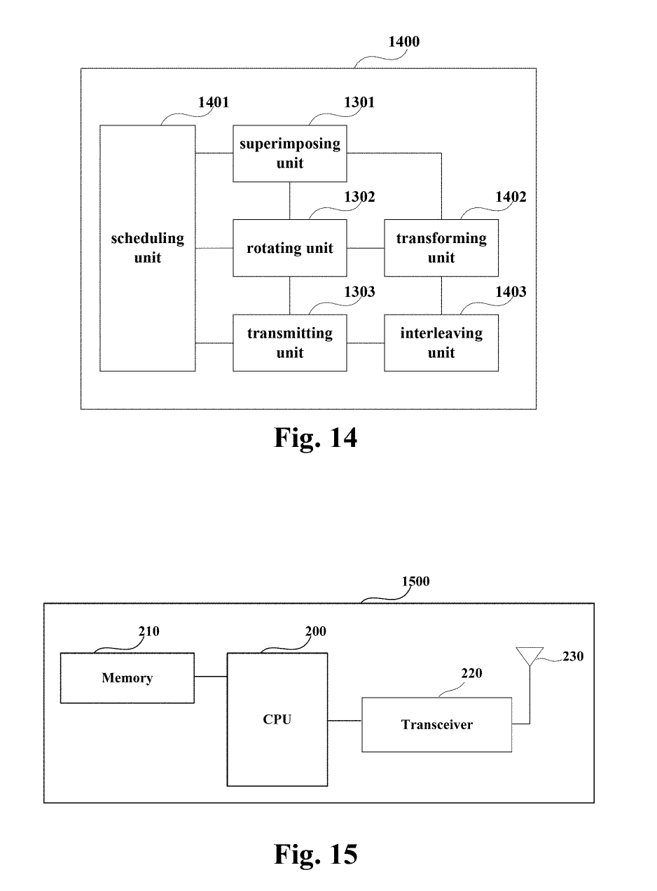

FIG. 14 is another schematic diagram of the apparatus for transmitting a signal of the embodiment of this disclosure. As shown in FIG. 14, the apparatus 1400 includes: a superimposing unit 1301, a rotating unit 1302 and a transmitting unit 1303, as described above.

As shown in FIG. 14, the apparatus 1400 may further include:

a scheduling unit 1401 configured to select multiple pieces of user equipment according to the channel conditions to perform NOMA scheduling.

As shown in FIG. 14, the apparatus 1400 may further include:

a transforming unit 1402 configured to equivalently transform the superimposed symbol to which the first antenna corresponds into a product of the rotated symbol and a phase reverse rotation coefficient; and

an interleaving unit 1403 configured to interleave the rotated symbols in different time domain resources and/or frequency domain resources;

and the transmitting unit 1303 is further configured to transmit the interleaved symbols by using the first antenna after multiplying them by the phase reverse rotation coefficient, and transmit the interleaved symbols directly by using the second antenna.

For example, the product of the rotated symbol and the phase reverse rotation coefficient may be expressed as:

(s₁+s₂)e^{jθk}^{ᵢ}e^{-jθk}^{ᵢ}; or

(s₁+s₂)e^{jθt}^{ᵢ}e^{-jθt}^{ᵢ}; or

(s₁+s₂)e^{jθk}^{ᵢ}^{t}^{ᵢ}e^{-jθk}^{ᵢ}^{t}^{ᵢ};

where, S1 and S2 are symbols respectively to be transmitted for first user equipment and second user equipment, θ is a predetermined phase value, kᵢ is a factor in a frequency domain, and tᵢ is a factor in a time domain.

In this embodiment, different pieces of user equipment performing the NOMA may use different phase rotation values. Furthermore, a phase value of the phase rotation is configured for the user equipment explicitly by the apparatus 1400 or acquired by the user equipment implicitly.

This embodiment further provides a transmitting device, configured with the apparatus 1300 or 1400 as described above.

FIG. 15 is a schematic diagram of a structure of the transmitting device of the embodiment of this disclosure. As shown in FIG. 15, the transmitting device 1500 may include a central processing unit (CPU) 200 and a memory 210, the memory 210 being coupled to the central processing unit 200. The memory 210 may store various data, and furthermore, it may store a program for information processing, and execute the program under control of the central processing unit 200.

The transmitting device 1500 may carry out the method for transmitting a signal described in Embodiment 1. And the central processing unit 200 may be configured to carry out the functions of the apparatus 1300 or 1400, that is, the central processing unit 200 may be configured to perform the following control: superimposing symbols which are to be transmitted to multiple pieces of user equipment to form a superimposed symbol; performing phase rotation on the superimposed symbol to form a rotated symbol; and transmitting the superimposed symbol by using a first antenna and transmitting the rotated symbol by using a second antenna, so that channel conditions of the multiple pieces of user equipment are differentiated.

Furthermore, as shown in FIG. 15, the transmitting device 1500 may include a transceiver 220, and an antenna 230, etc. Functions of the above components are similar to those in the relevant art, and shall not be described herein any further. It should be appreciated that the transmitting device 1500 does not necessarily include all the parts shown in FIG. 15, and furthermore, the transmitting device 1500 may include parts not shown in FIG. 15, and the relevant art may be referred to.

It can be seen from the above embodiment that, by forming the rotated symbol by performing phase rotation on the superimposed symbol and transmitting the superimposed symbol by using the first antenna and transmitting the rotated symbol by using the second antenna, channel conditions of multiple pieces of user equipment may be differentiated, and gains of NOMA in a microcell may be fully brought into play. Furthermore, with the transform and interleaving of the phase rotation symbols, gains of a signal spatial diversity may be created and utilized.

### Embodiment 3

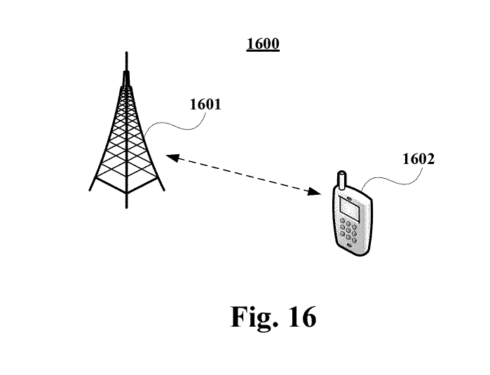

The embodiment of this disclosure provides a communications system, with contents identical to those in Embodiment 1 or 2 being not going to be described herein any further. FIG. 16 is a schematic diagram of the communications system of the embodiment of this disclosure. As shown in FIG. 16, the communications system 1600 includes a base station 1601 and user equipment 1602.

The base station 1601 is configured to superimpose symbols which are to be transmitted to multiple pieces of user equipment 1602 to form a superimposed symbol, perform phase rotation for the superimposed symbol to form a rotated symbol, and transmit the superimposed symbol by using a first antenna and transmits the rotated symbol by using a second antenna, so that channel conditions of the multiple pieces of user equipment 1602 are differentiated.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof. And they may also be realized as a combination of computing equipment, such as a combination of a DSP and a microprocessor, multiple processors, one or more microprocessors in communications combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A method for transmitting a signal, applied to a non-orthogonal multiple access (NOMA) system, the method comprising:
superimposing, by a transmitting device, symbols which are to be transmitted to multiple pieces of user equipment, to form a superimposed symbol;
performing phase rotation on the superimposed symbol to form a rotated symbol; and
transmitting the superimposed symbol by using a first antenna and transmitting the rotated symbol by using a second antenna, so that channel conditions of the multiple pieces of user equipment are differentiated.

2. The method according to claim 1, wherein the rotated symbol is:
(s₁+s₂)e^{jθk}^{ᵢ}^{t}^{ᵢ}; or
(s₁+s₂)e^{jθk}^{ᵢ}; or
(s₁+s₂)e^{jθt}^{ᵢ};
where, S1 and S2 are symbols respectively to be transmitted for first user equipment and second user equipment, θ is a predetermined phase value, kᵢ is a factor in a frequency domain, and tᵢ is a factor in a time domain.

3. The method according to claim 1, wherein a rotation factor of the phase rotation introduces time disturbance and/or frequency disturbance into a channel, so that the channel fluctuates in the frequency domain and/or the time domain to differentiate the channel conditions of the multiple pieces of user equipment.

4. The method according to claim 1, wherein the superimposed symbol is transmitted by using the first antenna and the rotated symbol is transmitted by using the second antenna in the same time-frequency resource.

5. The method according to claim 1, wherein the method further comprising:
selecting multiple pieces of user equipment according to channel conditions to perform NOMA scheduling.

6. The method according to claim 5, wherein the selecting multiple pieces of user equipment according to channel conditions to perform NOMA scheduling comprises:
scheduling two or more pieces of user equipment in the same sub-band for the purpose of maximizing a throughput; or
scheduling two or more pieces of user equipment with a difference between channel conditions thereof larger than a predetermined threshold in the same sub-band, for the purpose of ensuring a performance of successive interference cancellation; or
scheduling two or more pieces of user equipment with channel conditions thereof different from each other in the same sub-band, for the purpose of maximizing the number of users that are scheduled at the same time.

7. The method according to claim 1, wherein before transmitting the superimposed symbol by using the first antenna and transmitting the rotated symbol by using the second antenna, the method further comprises:
equivalently transforming the superimposed symbol to which the first antenna corresponds into a product of the rotated symbol and a phase reverse rotation coefficient;
interleaving the rotated symbols in different time domain resources and/or frequency domain resources; and
transmitting the interleaved symbols by using the first antenna directly after multiplying them by the phase reverse rotation coefficient, and transmitting the interleaved symbols directly by using the second antenna.

8. The signal transmitting method according to claim 7, wherein the product of the rotated symbol and the phase reverse rotation coefficient is expressed as:
(s₁+s₂)e^{jθk}^{ᵢ}e^{-jθk}^{ᵢ}; or
(s₁+s₂)e^{jθt}^{ᵢ}e^{-jθt}^{ᵢ}; or
(s₁+s₂)e^{jθk}^{ᵢ}^{t}^{ᵢ}e^{-jθk}^{ᵢ}^{t}^{ᵢ};
where, S1 and S2 are symbols respectively to be transmitted for the first user equipment and the second user equipment, θ is a predetermined phase value, kᵢ is a frequency domain factor, and tᵢ is a factor in the time domain.

9. The method according to claim 1, wherein different pieces of user equipment in the NOMA use different phase rotation values.

10. The method according to claim 1, wherein a phase value of the phase rotation is configured for the user equipment explicitly by the transmitting device, or acquired by the user equipment implicitly.

11. An apparatus for transmitting a signal, configured in a non-orthogonal multiple access (NOMA) system, the apparatus comprising:
a superimposing unit configured to superimpose symbols which are to be transmitted to multiple pieces of user equipment to form a superimposed symbol;
a rotating unit configured to perform phase rotation for the superimposed symbol to form a rotated symbol; and
a transmitting unit configured to transmit the superimposed symbol by using a first antenna and transmit the rotated symbol by using a second antenna, so that channel conditions of the multiple pieces of user equipment are differentiated.

12. The apparatus according to claim 11, wherein the rotated symbol is:
(s₁+s₂)e^{jθk}^{ᵢ}^{t}; or
(s₁+s₂)e^{jθk}^{ᵢ}; or
(s₁+s₂)e^{jθt}^{ᵢ};
where, S1 and S2 are symbols respectively to be transmitted for first user equipment and second user equipment, θ is a predetermined phase value, kᵢ is a factor in a frequency domain, and tᵢ is a factor in a time domain.

13. The apparatus according to claim 11, wherein a rotation factor of the phase rotation introduces time disturbance and/or frequency disturbance into a channel, so that the channel fluctuates in the frequency domain and/or the time domain to differentiate the channel conditions of the multiple pieces of user equipment.

14. The apparatus according to claim 11, wherein the superimposed symbol is transmitted by using the first antenna and the rotated symbol is transmitted by using the second antenna in the same time-frequency resource.

15. The apparatus according to claim 11, wherein the apparatus further comprising:
a scheduling unit configured to select multiple pieces of user equipment according to channel conditions to perform NOMA scheduling.

16. The apparatus according to claim 11, wherein the apparatus further comprising:
a transforming unit configured to equivalently transform the superimposed symbol to which the first antenna corresponds into a product of the rotated symbol and a phase reverse rotation coefficient; and
an interleaving unit configured to interleave the rotated symbols in different time domain resources and/or frequency domain resources;
and the transmitting unit is further configured to transmit the interleaved symbols by using the first antenna after multiplying them by the phase reverse rotation coefficient, and transmit the interleaved symbols directly by using the second antenna.

17. The apparatus according to claim 16, wherein the product of the rotated symbol and the phase reverse rotation coefficient is expressed as:
(s₁+s₂)e^{jθk}^{ᵢ}e^{-jθk}^{ᵢ}; or
(s₁+s₂)e^{jθt}^{ᵢ}e^{-jθt}^{ᵢ}; or
(s₁+s₂)e^{jθk}^{ᵢ}^{t}^{ᵢ}e^{-jθk}^{ᵢ}^{t}^{ᵢ};
where, S1 and S2 are symbols respectively to be transmitted for first user equipment and second user equipment, θ is a predetermined phase value, kᵢ is a factor in a frequency domain, and tᵢ is a factor in a time domain.

18. The apparatus according to claim 11, wherein different pieces of user equipment in the NOMA use different phase rotation values.

19. The apparatus according to claim 11, wherein a phase value of the phase rotation is configured for the user equipment explicitly by the apparatus, or acquired by the user equipment implicitly.

20. A communications system, comprising:
a base station configured to superimpose symbols which are to be transmitted to multiple pieces of user equipment to form a superimposed symbol, perform phase rotation for the superimposed symbol to form a rotated symbol, and transmit the superimposed symbol by using a first antenna and transmit the rotated symbol by using a second antenna, so that channel conditions of the multiple pieces of user equipment are differentiated.
